(19) United States
(12) Patent Application Publication
(10) Pub. No.: US 2026/0024902 A1
(43) Pub. Date: Jan. 22, 2026

(54) Breathable Plug

(71) Applicant: Illinois Tool Works Inc., Glenview, IL (US)

(72) Inventors: Laurent Huet, Meru (FR); Eric Leverger, Epone (FR); Fulvio Pacifico Yon, Donnas (IT)

(21) Appl. No.: 19/271,956

(22) Filed: Jul. 17, 2025

(30) Foreign Application Priority Data
Jul. 19, 2024 (EP) 24189821.2
Nov. 18, 2024 (EP) 24213703.2
Mar. 26, 2025 (EP) 25166310.0
Jun. 30, 2025 (DE) 10 2025 125 397.8

(51) Int. Cl. H01M 50/655; H01M 50/308

(52) U.S. Cl. CPC H01M 50/655; H01M 50/308

(57) ABSTRACT

A breathable plug designed for use with a breathable plug fixture. The plug allows gas to pass through while preventing the passage of liquids. It includes a resilient external thread that enables installation via an interference push fit. The external thread also features one or more wings positioned between the root and the crest of the thread.

### RELATED APPLICATIONS

The present application claims the benefit of European Patent Application No. 24189821.2, filed Jul. 19, 2024, European Patent Application No. 24213703.2, filed Nov. 18, 2024, European Patent Application No. 25166310.0, filed Mar. 26, 2025, and German Patent Application No. 10 2025 125 397.8, filed Jun. 30, 2025, each titled “Breathable Plug,” the contents of which are hereby incorporated by reference.

### BACKGROUND

The present application relates to a breathable plug.

Electric vehicles are increasingly provided with an electric drive module to convert the stored battery power into movement at the wheels. The electric drive module houses mechanical components which require cooling and lubrication, typically by oil. The system cannot be run in a closed configuration due to oil expansion and also to allow vapor (such as water vapor) to escape the system.

Due to the moving parts oil is splashed around inside the electric drive module, and this can result in the suspension or dispersal of oil droplets which risk escaping through any vent or filter that the system is provided with. This is problematic as it can reduce the amount of oil available in the system through losses, it also presents an environmental hazard.

### SUMMARY

The present disclosure relates generally to a breathable plug, substantially as illustrated by and described in connection with at least one of the figures, as set forth more completely in the claims.

### DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1 illustrates a cross section of a breathable plug fixture.

FIGS. 2A and 2B illustrate, respectively, a breathable plug fixture aligned with a substrate prior to fitting and a breathable plug fixture fitted to a substrate.

FIGS. 3A and 3B illustrate, respectively, a partial cross section of a breathable plug fixture in an unlocked position and a partial cross section of a breathable plug fixture in a locked position.

FIG. 4 illustrates a cross section of an alternative breathable plug fixture.

FIG. 5 illustrates a cross section of an alternative breathable plug.

FIGS. 6A and 6B illustrate, respectively, cross section views of the alternative breathable plug of FIG. 5 in a first position and in a second position.

FIG. 7 illustrates a plug insert for a breathable plug.

FIG. 8 illustrates an alternative plug insert for a breathable plug.

FIG. 9 illustrates an alternative breathable plug.

FIG. 10 illustrates a cross section of a fixture body suitable for use in a breathable plug.

FIGS. 11A through 11C illustrate, respectively, a partially manufactured breathable plug, a cross section of a breathable plug, and a breathable plug.

FIGS. 12A through 12C illustrate, respectively, a further view of a breathable plug, a cross section of the breathable plug, and an exploded view of the breathable plug.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The disclosure presents a breathable plug that is suitable for use with a breathable plug fixture, which simultaneously prevents the passage of liquid and permits the passage of gas. The breathable plug comprises a resilient external thread, to allow for installation of the breathable plug by interference push fit. The resilient external thread further comprises one or more wings arranged between a root and a crest of the resilient external thread. The resilient thread and wings act as contact surfaces for liquid droplets to contact and coalesce. The resilient thread then channels the collected liquid back to the side from which the liquid droplets originated (e.g. An oil tank via gravity).

Preferably, the one or more wings are arranged within the pitch of the resilient external thread, and/or, the one or more wings are arranged between a major thread diameter and a minor thread diameter of the resilient external thread, and/or, the one or more wings are arranged to capture liquid droplets and/or to direct the captured liquid droplets, and/or the one or more wings are attached to at least one flank of the resilient external thread, and/or the one or more wings at least partially occlude a gap formed between opposing flanks of the resilient external thread, and/or the one or more wings vary in size and/or shape and/or topology. These features are intended to maximize the amount of liquid droplets collected and therefore the efficiency and effectiveness of the breathable plug.

Appositely, the breathable plug is further provided with a gas permeable membrane and/or wherein the resilient external thread provides a labyrinth portion. Both the labyrinth portion and the gas permeable membrane provide extra defenses against liquid droplets passing through the breathable plug, while still permitting the passage of gases. Suitably, the breathable plug is further provided with one or more filters for similar reasons.

Preferably, the breathable plug further comprises a fixture body capable of providing a fluid tight seal when located within a plug hole. The fixture body provides a structure to facilitate handling of the breathable plug which may be soiled by liquid and also to house further elements of the breathable plug, such as filters, membranes, and the like.

The fixture body may comprise a passage, a membrane may be located to occlude the passage. The resilient external thread may be associated (e.g. Inserted within) with the passage, and optionally wherein the fixture body may comprise a void space that is connected to an exterior via the passage. Suitably, the fixture body may be further provided with one or more filters.

The breathable plug may further comprise a support section arranged to contact the membrane, and further optionally, to support, the membrane. The support section prevents unintentional distortion or tearing of the membrane. The support section may be arranged to intentionally deform the membrane so as to encourage run off of liquid, so that liquid cannot pool, and thereby prevent the passage of gas through, the membrane. The liquid may be, for example, water ingress.

Appositely, the membrane may be supported in a central region by the support section and optionally or alternatively, wherein the support section, in use, deforms the membrane, and further optionally, the support section deforms the membrane such that a runoff of a liquid from the membrane is facilitated.

Preferably, the resilient external thread is located in the passage of the fixture body. Suitably, the support section extends across a fixation point of the membrane. Here “extends across” means the support section traverses a plane defined by the fixation point or otherwise, such that the support section projects across, obliquely or perpendicularly to, the plane.

Optionally the support section extends across the fixation point by a distance that corresponds to an amount of deformation of the membrane (404). In other words, the membrane is deformed by an amount that corresponds to an amount (e.g. Length, volume, etc.) of the support section that exceeds the plane defined by the fixation point.

Appositely, the fixture body further comprises one or more gates. Optionally, the one or more gates are fluidly connected to a face of the membrane and/or an exterior of the breathable plug, such that the gates may permit the passage of a fluid away from that face of the membrane and to the exterior of the fixture body.

Suitably, a gate labyrinth is provided between a one of the one or more gates and the membrane and/or the exterior of the breathable plug. The gate labyrinth is intended to hinder the flow of liquid between the exterior and the interior of the fixture body. The gate labyrinth may be biased, such that the flow of liquid is easier in one direction through the labyrinth compared to the opposite direction. This may be achieved by designing the labyrinth with weirs, air pockets, angled surfaces to hinder the progress of liquid.

Preferably, the breathable plug further comprises a resilient seal that is arranged to form a fluid tight seal between the breathable plug and a surface. The resilient seal may be located on an exterior of the fixture body such that it is arranged to contact, and seal against, a further surface to prevent the passage of liquids and/or gases across the resilient seal.

Suitably, the resilient seal may be formed by overmolding directly onto the breathable plug. The breathable plug may be provided with one or more keying features in which the resilient seal is overmolded onto. The keying features provide a topology to which a secure mechanical grasp can be made by the resilient seal and increases surface area between the parts thereby maximizing any chemical bond that may form between the parts. By way of non-limitative example, the keying features may have a cross section which is dovetail like in shape.

Also, according to the disclosure there is provided a breathable plug fixture, suitable to prevent the passage of liquid droplets, comprising a breathable plug as described elsewhere in this disclosure.

Suitably, the breathable plug fixture comprises a fixation portion having an aperture arranged to receive the breathable plug. The breathable plug may be associated with the aperture, such that the breathable plug fixture is supplied ready to use, and/or that the breathable plug may not escape a loose associate with the breathable plug fixture (i.e. The parts are retained in close proximity even when the breathable plug is not in a liquid-tight seal with the breathable plug fixture).

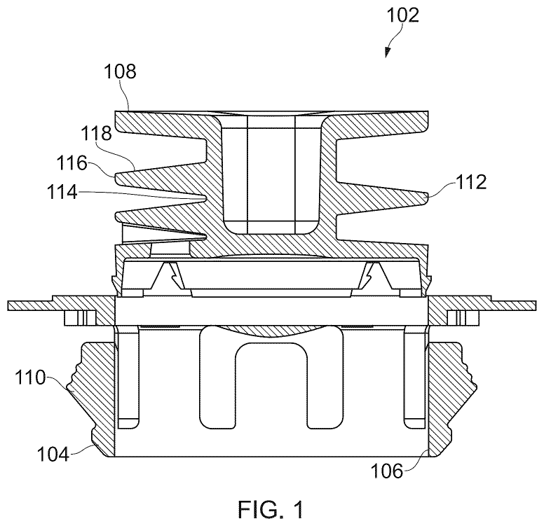

As shown in FIGS. 1, 2A, 2B, 3A, and 3B there is provided a breathable plug fixture 102 suitable for simultaneously preventing the passage of liquid (typically oil) and permitting the passage of gas (such as water vapor).

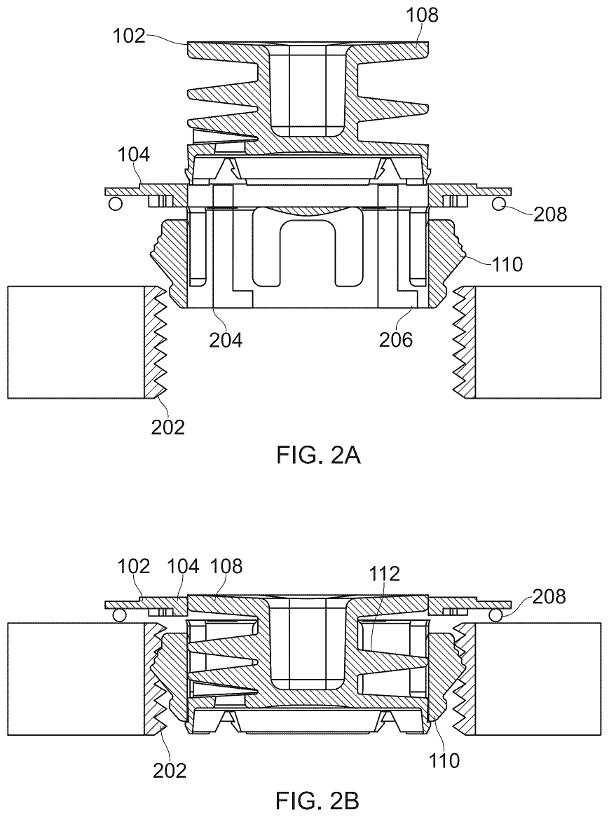

The breathable plug fixture comprises a fixation portion 104 comprising an aperture 106 arranged to receive a breathable plug 108 and one or more external resilient clips 110 having a surface complementary to a substrate surface. The fixation portion 104 provides a connection between the breathable plug fixture 102 and a vehicle. A seal (not shown in FIG. 1, item 208 in FIGS. 2A AND 2B) is provided between a lip of the fixation portion 104 to interface with a surface of the vehicle (substrate), although it will be apparent that a seal may be arranged at any suitable location on the fixation portion 104 provided the function of sealing the connection is provided (i.e. Preventing the passage of both liquid and gaseous fluids). The at least one resilient seal 208, is arranged to, in use, compress against a substrate surface and apply a tension between the fixation portion and the substrate surface. This prevents unintentional separation of the parts. The at least one resilient seal 208 also provides increased sealing with increasing pressure as this results in greater compression of the seal between the fixation portion 104 and the substrate.

The external resilient clips 110 provide gripping means for the fixation portion 104 to grasp and be retained within the vehicle substrate. By making the external resilient clips 110 resilient, fitting time of the breathable plug fixture 102 is reduced as the fixation portion 104 may simply be pushed into place with a “snap-fit” (i.e. The part does not need screwing or welding into place). The surface complementary to a substrate surface (i.e. The surface of the vehicle to which the fixation portion 104 is fitted) is a threaded surface, in order to provide a more effective connection between the parts.

As the location of the breathable plug fixture 102 is likely to experience relatively elevated temperatures, though the drive means heating up in use, the fixation portion 104 should be formed of a material appropriate to deal with such temperatures, such as a suitable plastic.

A breathable plug 108 is associated with the aperture. The breathable plug fixture 102 may be supplied with the breathable plug 108 captured by the fixation portion 104 in the aperture or partially inserted into the aperture. The breathable plug has a resilient external thread 112 having a dimension sufficient to form an interference push fit with the aperture. In this way the breathable plug 108 can be fitted to the aperture simply by pushing the breathable plug 108 inside. The aperture does not therefore comprise complementary threads and may have a smooth side wall. The resilient external thread 112 may act as a conduit for returning oil to the vehicle, which may trickle down the resilient external thread.

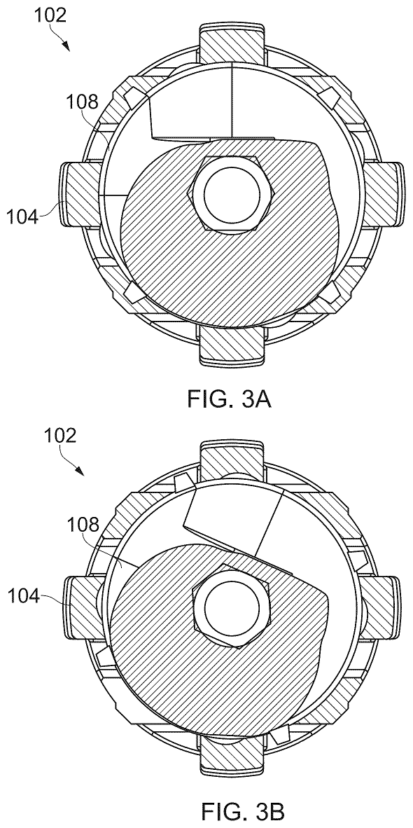

The breathable plug fixture further comprises a lock 206 arranged to fix the position of the breathable plug relative to the fixation portion. The lock ensures that the breathable plug 108 is securely held in place in the aperture of the fixation portion 104 and will not unintentionally disassociate from the fixation portion 104 e.g. Through road vibrations. The lock may take the form of a slot into which teeth may be rotated, similar to a bayonet fitting. The rotation to affect a secure lock may be minimal, e.g. With reference to FIGS. 3a and 3b, the lock may be engaged through a rotation of an eighth of a turn or less. Preferably the lock may be engaged by hand, without any additional tools. The breathable plug 108 may be provided with an interface to engage with a tool (such as a spanner, hex key, star driver or any similar) to allow for rotation of the breathable plug 108 which may operate the lock 206 or allow the breathable plug 108 to be rotated out of the aperture via the resilient external thread.

Preferably, the resilient external thread, when in use, permits the passage of gas but prevents the passage of liquid. This may be affected by selecting an appropriate pitch or number of threads to provide a labyrinth or riddle through which liquid may not pass, but gas may.

The breathable plug fixture can further comprise at least one guide portion 204 arranged to facilitate reception of the breathable plug by the fixation portion. The at least one guide portion 204 may be a slot and running member arranged on either the breathable plug or fixation portion respectively. The guide ensures the correct location and fitment of the parts and also stops rotation of the part in the aperture.

FIGS. 2a and 2b show the fitment of the breathable plug fixture 102. The fixation portion 104 is pushed into, for example, a threaded hole in the vehicle. The breathable plug fixture 102 is then fully pushed into the fixation portion 104. The 102 may then be locked as shown in FIGS. 3a and 3b by rotating the breathable plug 108 by hand.

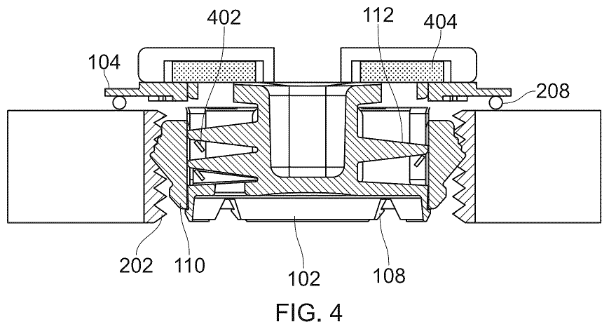

An alternative breathable plug fixture 102 is shown in FIG. 4. The breathable plug fixture 102 is also suitable to simultaneously prevent the passage of liquid and permit the passage of gas and shares many similar features to the breathable plug fixture 102 of FIG. 1. These are provided with like numerals and not further discussed in order to prevent unnecessary repetition.

The breathable plug fixture comprises a fixation portion 104 comprising an aperture 106 arranged to receive a breathable plug 108. The breathable plug 108 is associated with the aperture and comprises a resilient external thread 112 having a dimension sufficient to form an interference push fit with the aperture.

The resilient external thread further comprises one or more wings 402 arranged between a root 114 and a crest 116 of the resilient external thread. Here, root 114 and crest 116 refer to the properties of a screw thread. The root 114 is the bottom of the groove between the two flanking surfaces of the thread and the crest 116 is the is the prominent part of a thread (outermost). The flank 118 is the surface of the thread connecting a given crest 116 and root 114.

The purpose of the wings 402 is to capture dispersed oil droplets so they run down the wings 402 and onto the resilient external threads 112 and then trickle back down into the drive unit. So, the one or more wings are arranged to capture liquid droplets and/or to direct the captured liquid droplets.

The one or more wings may be arranged within the pitch of the resilient external thread (i.e. the valley formed between two respective crests 116).

The one or more wings can be arranged between a major thread diameter and a minor thread diameter of the resilient external thread, i.e. Between the crest 116 and root 114 of the resilient external thread 112.

To achieve the above arrangements the one or more wings are attached to at least one flank of the resilient external thread, and therefore in the path of any dispersed oil droplets in the resilient external thread. The one or more wings therefore at least partially occlude a gap (or valley as described before) formed between opposing flanks of the resilient external thread.

The breathable plug can be further provided with a gas permeable membrane 404, although this is not essential. The gas permeable membrane may permit gas to escape but capture any remaining dispersed oil droplets which escape the breathable plug. The gas permeable membrane may be any suitable such as an aluminum filter, non-woven mesh, membrane or sintered filter. The gas permeable membrane may be added on the top of the breathable plug and locked with a cap, over molded, welded, or otherwise suitably fixed to the breathable plug.

By using the above-described breathable plugs of FIG. 1 (the breathable plug fixture 102 of FIG. 1 may also be provided with a gas permeable membrane similar to FIG. 4) and FIG. 4 any attached filter stays cleaner by stopping oil droplets contaminating the filter, therefore a longer duration between services may be permitted.

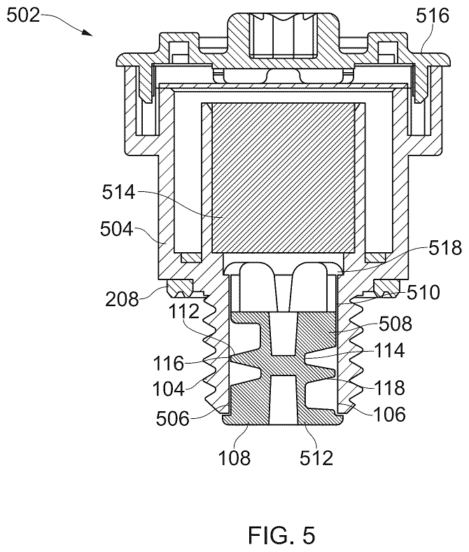

An alternative breathable plug (breathable plug 502) is shown in FIG. 5. The breathable plug 502 is also suitable to simultaneously prevent the passage of liquid and permit the passage of gas and shares many similar features to the breathable plug 108 of FIG. 1 and FIG. 4. These are provided with like numerals and not further discussed in order to prevent unnecessary repetition. The breathable plug 502 may be used with and/or substituted for any other breathable plug or breathable plug fixture disclosed herein. Likewise, elements of the alternative breathable plug 502 may be incorporated or substituted into any other breathable plug disclosed herein.

The breathable plug 502 is intended to be used with a pre-existing breathable plug fixture 102 and may therefore be retrofitted or provide a replacement part to a pre-existing installation.

The breathable plug 502 of FIG. 5 differs in that the breathable plug 502 is a complete plug (i.e. Absent a mounting bracket and/or is adapted to be inserted as a conventional plug into an existing plug hole).

The breathable plug 502 comprises a fixture body 504 which forms the space filling part of the breathable plug 502. A plug insert 512 is inserted into the fixture body 504. The plug insert 512 may comprise the aforementioned resilient external thread 112 and associated features.

The plug insert 512 is provided with resilient plug portion clips 518 to grasp an interior void of the fixture body 504 when inserted within a channel of the fixture body 504.

The plug insert 512 is provided with one or more holes 702 to allow air/gas into a labyrinth portion 508 formed of the previously discussed resilient external thread 112.

The breathable plug 502 is suitable to simultaneously prevent the passage of liquid (or dispersed liquid droplets, or the liquid component of an aerosol) and permit the passage of gas across the breathable plug 502.

The breathable plug comprises a fixture body 504 capable of providing a fluid tight seal when located within a plug hole. The fixture body 504 has a void space connected to an exterior via a passage 506. The plug insert 512 is associated with the passage 506 and comprises a resilient external thread 112 having a dimension sufficient to form an interference push fit with the passage 506. This is sufficient to prevent fluid flow across the breathable plug 502, unless via the labyrinth portion 508. The resilient external thread, when in use, permits the passage of gas but prevents the passage of liquid across the breathable plug. Optionally, the resilient external thread provides the labyrinth portion 508.

The breathable plug fixture 102, 502, 1102, may be further provided with one or more filters 514, which may have one or more functions, e.g. To prevent passage of any liquid that does pass through the labyrinth portion 508 or to remove contaminants from any gas. The filters 514 may comprise a gas permeable membrane.

Plug portion clips 518 fasten the plug insert 512 inside the fixture body 504. Holes 702 are provided for the air/gas flow entrance inside the labyrinth insert. The holes 702 are provided in the resilient external thread 112 for the air/gas flow into and exit from the labyrinth portion 508.

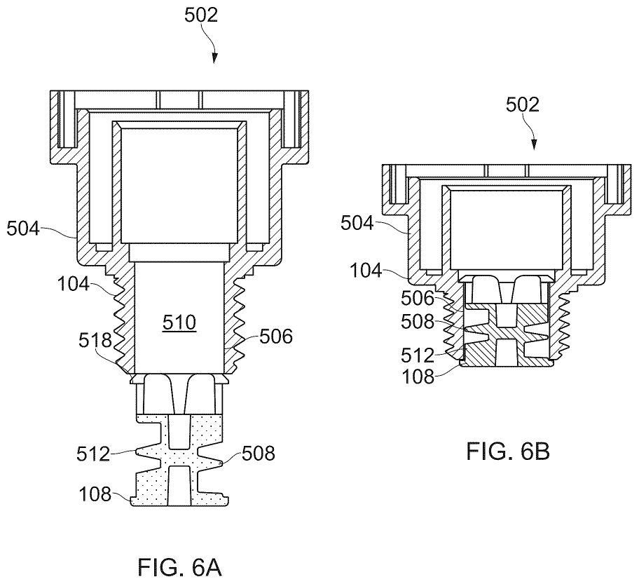

FIG. 6A shows the construction method of the breathable plug 502, plug insert 512 is located adjacent the void space 510, and then urged within the void space 510 of the fixture body 504. FIG. 6B shows the constructed breathable plug 502 with the plug portion clips 518 of the plug insert 512 engaged with the fixture body 504. A seal 208 may be provided to the fixture body 504 to ensure an effective seal between the breathable plug 502 and a plug hole into which the breathable plug 502 is inserted. A cover 516 (see FIG. 5) may be provided to provide a mechanical closure to prevent egress of fluids across the breathable plug 502.

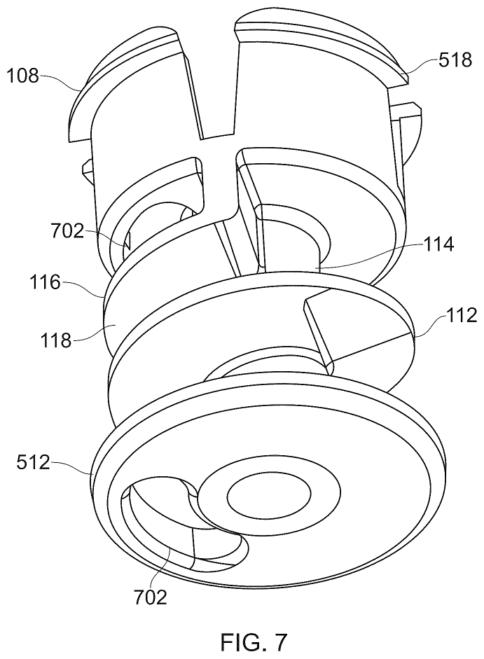

FIG. 7 shows a plug insert 512 absent the fixture body 504.

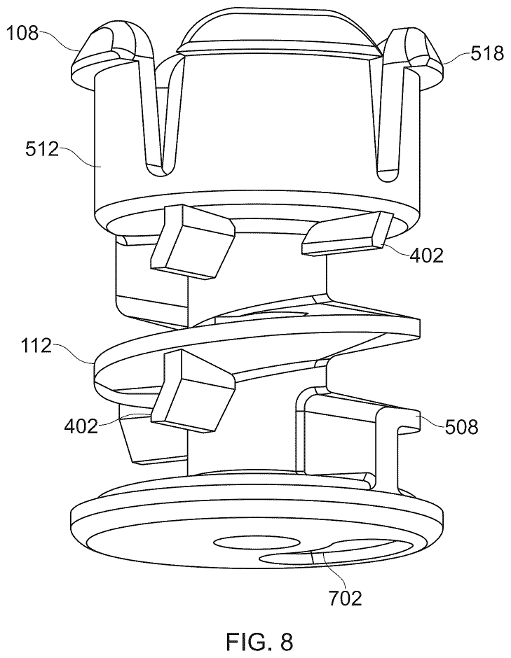

FIG. 8 shows a plug insert 512, similar to the plug insert 512 of FIG. 7 but further comprising one or more wings 402. The wings 402 increase the ability of the labyrinth to prevent the passage of liquid droplets across the breathable plug 502. The droplets collect upon the wings 402 and drip back down through the Holes 702 of the plug insert 512. The wings are similar to those described elsewhere in this description and may possess the same attributes. The resilient external thread may comprise the one or more wings, and the wings can be arranged between a root 114 and a crest 116 of the resilient external thread. Optionally the one or more wings vary in size, shape, or topology to maximize the kinds of droplets caught in the labyrinth portion 508 (different droplet sizes and liquids requiring different capturing surfaces).

The one or more wings can be arranged within the pitch of the resilient external thread. The one or more wings may be arranged between a major thread diameter and a minor thread diameter of the resilient external thread.

The one or more wings can be arranged to capture liquid droplets and/or to direct the captured liquid droplets.

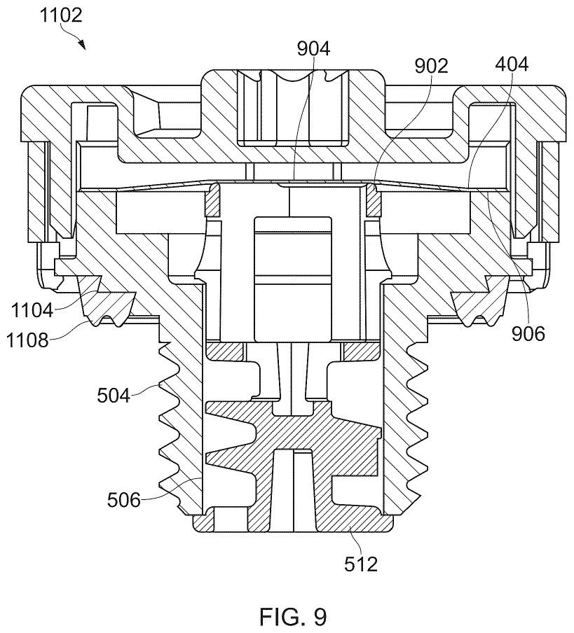

FIG. 9 shows an alternative breathable plug 1102 suitable to simultaneously prevent liquid passing and to permit gas to pass across the breathable plug. The breathable plug 1102 may be used with and/or substituted for any other breathable plug or breathable plug fixture disclosed herein. Likewise, elements of the alternative breathable plug 1102 may be incorporated or substituted into any other breathable plug disclosed herein.

The breathable plug 1102 comprises a fixture body 504 as hereinbefore described and capable of providing a fluid tight seal when located within a plug hole.

The fixture body 504 comprising a passage 506 as previously described. A membrane 404 is provided and located to occlude the passage 506. This may be at an end of the passage 506 or any suitable location within the passage 506 provided the membrane 404 may perform its function of excluding some fluids to pass while permitting other fluids to pass. The membrane may therefore be the gas permeable membrane 404 previously described.

A plug insert 512 is associated with the passage 506 (such as located within or otherwise inserted into the passage 506). The plug insert 512 may comprise a support section 902 arranged to contact, and optionally support, the membrane 404. A support section may be provided in alternative locations of the breathable plug provided that the function of the support section is the same as described. The support section 902 may be an extension of the breathable plug 108 provided by a cylinder wall of the fixation portion for example. The support section 902 need not be formed of a cylindrical wall and any suitable construction may be used provided that the support section 902 is arranged to contact the membrane. The support section 902 may therefore be a grid, platform, table, tripod, post, or any other suitable construction provided that the support section 902 does not prevent the membrane 404 from functioning as described above.

Optionally the membrane 404 is supported in a central region 904 by the support section 902 (e.g. The geometric center of the shape of the membrane). If the membrane 404 is circular for example, the membrane may be supported towards the center of that circle.

The support section 902, may, in use, deform the membrane 404 such as by stretching or at least displacing one region of the membrane relative to another region of the membrane (e.g. causing a bend, dimple, or depressed region as viewed from the direction of the support section contacting the membrane).

Optionally, the support section 902 deforms the membrane 404 such that a runoff of a liquid from the membrane 404 is facilitated on a side of the membrane that is opposite to the side the support section contacts the membrane. The support section 902 may form a ridge or pinnacle in the membrane relative to other areas of the membrane which would encourage a liquid to flow, via gravity, from a high region of the membrane to a low region of the membrane. Preferably, the low region of the membrane is arranged adjacent a flow path to a drain or gates of the breathable plug 1102. The high region of the membrane may be remote from the drain or gate; therefore liquid is encouraged to flow towards the drain or gate from the high region and across the low region of the membrane.

When the plug insert 512 is located in the passage 506 of the fixture body, the support section 902 may extend across a fixation point 906 of the membrane 404. This is to ensure deformation of the membrane as the membrane would otherwise remain in an at rest position across the fixation points (i.e. In a flat formation). By arranging the support section 902 such that it exceeds the fixation points 906, the membrane must deform across the support section 902 between fixation points 906. It will be apparent that the extension of the support section 902 beyond the fixation point 906 may be any suitable distance provided that the integrity of the membrane and/or fixation points 906 are not compromised (e.g. The support section 902 does not cause the membrane to rupture or impair the function of the membrane). It will be apparent that the support section 902 extends across the fixation point 906 by a distance that corresponds to an amount of deformation of the membrane 404 and that this distance may be varied to achieve different amounts of membrane distortion. The support section may not provide a consistent distance (i.e. The support section may exceed the fixation points 906 by different amounts across the support section 902). A given membrane may be deformed by different amounts by a given support section 902 across the surface of the membrane.

Supporting and/or deforming the membrane avoids vibration from, for example, a vehicle engine or motor, deforming the membrane in a variable and uncontrolled manner, or when the membrane is under the weight of an external water pressure (thereby causing fluid to pool on and occlude the membrane). This improves the durability, and minimizes failure of, the membrane.

Encouraging fluid to flow off of the membrane preserves the functionality of the membrane and prevents soiling/contamination e.g. From salts (such as calcium carbonate) in the liquid (e.g. Water) crystallizing as the liquid dries and thereby fouling the membrane.

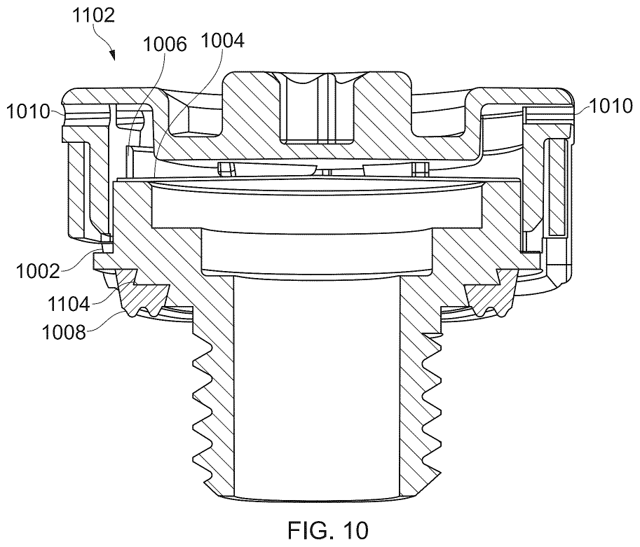

Per FIG. 10, the fixture body 504 may further comprise one or more gates 1002 to allow fluid to pass from the interior of the breathable plug to the exterior (e.g. To allow water to drain).

The one or more gates 1002 may be fluidly connected to a face 1004 of the membrane 404 (i.e. A single side of the membrane so fluid must pass through the membrane, or return from that face of the membrane having failed to pass through). The gates 1002 may also be fluidly connected to an exterior of the breathable plug 1102 to allow fluid to drain or otherwise be expelled from the breathable plug.

A gate labyrinth 1006 may be provided between a one of the one or more gates 1002 and the membrane 404 and/or the exterior of the breathable plug 1102. The gate labyrinth acts to catch fluids entering the breathable plug from the exterior through the gates 1002 and prevents such fluid from reaching the membrane e.g. Liquid droplets entering through the gates 1002 may collect on the gate labyrinth and be returned to the exterior via the gate. The gate labyrinth 1006 therefore prevents such liquid droplets reaching the membrane and avoids the risk of fouling or otherwise contaminating the membrane to preserve membrane functionality.

The gates 1002 are fluidly connected to one or more breathing windows 1010 arranged on the exterior of the fixture body 504 to allow gases to vent from the fixture body 504.

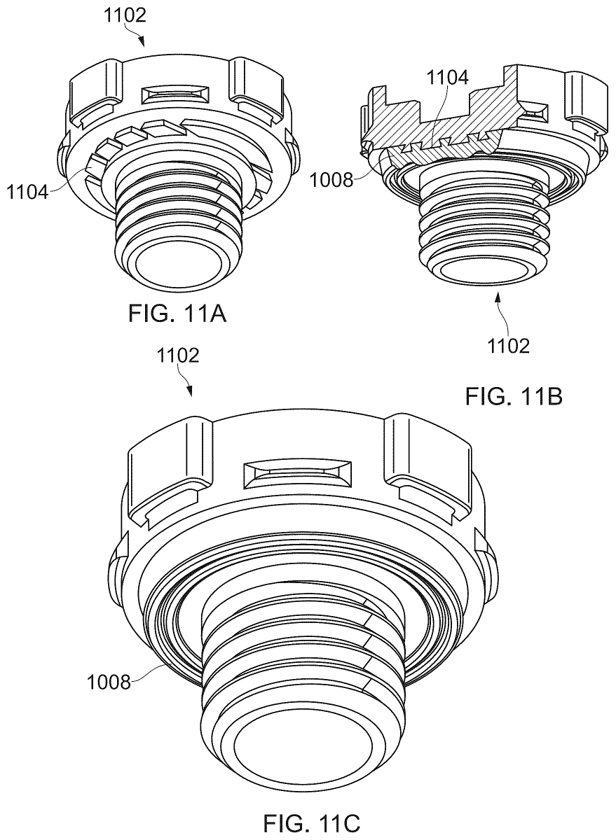

As shown in FIGS. 11a, 11b, and 11c, in a further alternative breathable plug 1102, which may any as previously discussed or separate, a resilient seal 1008 is arranged to form a fluid tight seal between the breathable plug 1102 and a surface (e.g. fixation portion 104 or panel). The resilient seal 1008 is formed by directly overmolding the seal onto the breathable plug 1102, for example in a two-stage injection molding process.

To ensure a good mechanical attachment between the resilient seal 1008 and the breathable plug 1102 (e.g. To prevent the resilient seal 1008 disconnecting from the breathable plug 1102 during rotation of the breathable plug 1102), the breathable plug 1102 is provided with one or more keying features 1104 which the resilient seal 1008 is overmolded onto thereby providing a gripping surface for the resilient seal 1008 to key into as it is molded.

Optionally the resilient seal is arranged on a fixture body. The keying features may have any suitable cross section provided that the cross section selected allows the keying features 1104 to provide their function of giving a suitable mechanical bond between the resilient seal 1008 and the breathable plug 1102. It will be apparent that “suitable mechanical bond” will vary dependent on the application the breathable plug is being used for with some applications requiring a relatively more secure mechanical bond than others. By way of non-limitative example, a dovetail-like shape is a suitable cross section, but any other trapezoidal, ovid, mushroom or like shape may be used as well as still others.

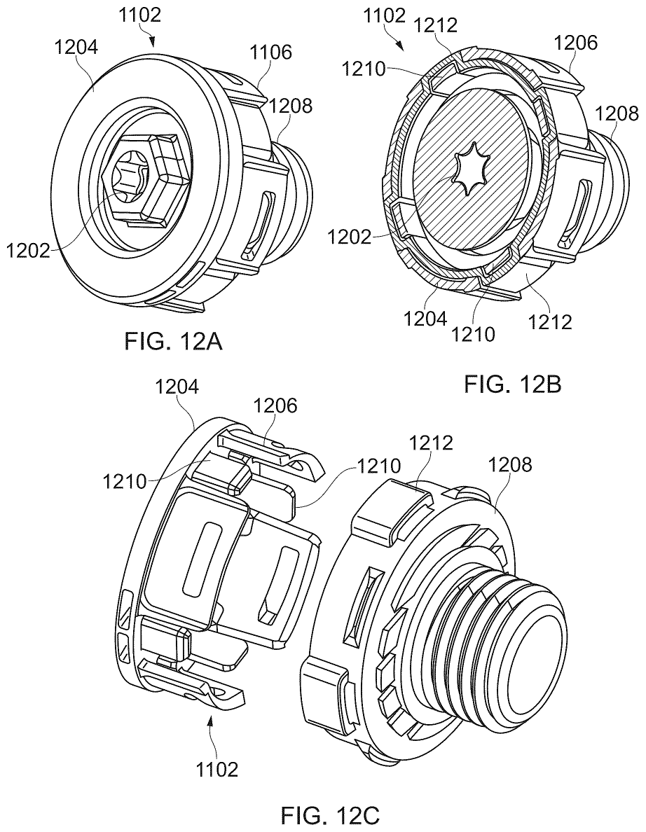

As shown in FIGS. 12a, 12b, and 12c, the breathable plug 1102 further comprises driving means 1202 to allow a tool to interface with the breathable plug 1102 and apply rotation to the breathable plug 1102 to assist in insertion or removal. The drive means shown is a Torx™ system, but any other drive means may be used including, but not limited to a hexagonal head or socket, star drive, Pozi, Philips or slot for example.

The drive means 1202 may be provided on a cap 1204 which forms part of the breathable plug 1102. The cap 1204 may be arranged to snap-fit by one or more resilient legs 1206 onto a lower body 1208 of the breathable plug 1102.

One or more lugs 1210 may be provided on either the cap or lower body and arranged to connect with one or more corresponding lugs sockets 1212 on the opposite part (cap or lower body depending on where the lugs are placed). The lugs and log sockets provide mechanical communication between the parts and allow for the transfer of rotation forces applied to the cap to the lower body in order to ensure that the lower body rotates with the cap and that the two are not unintentionally separated.

The lug sockets may also act as, or also provide the function of, breathing windows 1010. The lug sockets may therefore be provided as loops of materials forming a short tunnel open at both ends and provided in fluid communication with the gates 1002. Excess lug sockets may be provided above the number of lugs to ensure easy attachment of the cap to the lower body and to ensure function as breathing windows 1010. In addition or separately, the lug sockets and lugs may be arranged to have a baggy or otherwise loose fit to sufficient to allow gases to pass across the lug sockets and for the breathing windows 1010 to function. A baggy fit does not necessarily mean there may be play between the parts when rotation is applied to the cap, the shapes selected for the lug and lug socket may be sufficient to allow gas to pass, but tight enough that no play between the cap and lower body is experienced when applying torque to the cap.

It will be appreciated by persons skilled in the art that the above detailed examples have been described by way of example only and not in any limitative sense, and that various alterations and modifications are possible without departing from the scope of the disclosure as defined by the appended claims. Various modifications to the detailed examples described above are possible.

Through the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

The above-cited patents and patent publications are hereby incorporated by reference in their entirety. While the present method and/or system have been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A breathable plug (108), suitable for use with a breathable plug fixture (102, 502) which simultaneously prevents the passage of liquid and permits the passage of gas, the breathable plug comprising:
a resilient external thread (112) to allow for installation of the breathable plug by interference push fit,
wherein the resilient external thread further comprises one or more wings (402) arranged between a root (114) and a crest (116) of the resilient external thread.

2. The breathable plug of claim 1,
wherein the one or more wings are arranged within the pitch of the resilient external thread, and/or
wherein the one or more wings are arranged between a major thread diameter and a minor thread diameter of the resilient external thread.

3. The breathable plug of claim 1, wherein the breathable plug is further provided with a gas permeable membrane and/or wherein the resilient external thread provides a labyrinth portion (508).

4. The breathable plug of claim 1, wherein the breathable plug (108) is further provided with one or more filters (514).

5. The breathable plug (108) of claim 1, further comprising:
a fixture body (504) capable of providing a fluid tight seal when located within a plug hole;
the fixture body (504) comprising a passage (506);
a membrane (404) located to occlude the passage (506),
wherein the resilient external thread (112) is associated with the passage (506), and wherein:
the fixture body (504) comprises a void space (510) connected to an exterior via the passage (506), and/or
the fixture body (504) is further provided with one or more filters (514), and/or optionally
the breathable plug further comprises a support section (902) arranged to contact the membrane, and further optionally, to support, the membrane (404).

6. The breathable plug (1102) of claim 5, wherein the membrane (404) is supported in a central region (904) by the support section (902), wherein the support section (902), in use, deforms the membrane (404), and further optionally, the support section (902) deforms the membrane (404) such that a run off of a liquid from the membrane (404) is facilitated.

7. The breathable plug (1102) of claim 5, wherein, when the resilient external thread (112) is located in the passage (506) of the fixture body, the support section (902) extends across a fixation point (906) of the membrane (404), and wherein the support section (902) extends across the fixation point (906) by a distance that corresponds to an amount of deformation of the membrane (404).

8. The breathable plug (1102) of claim 5, wherein the fixture body (504) further comprises one or more gates (1002), and optionally
wherein the one or more gates (1002) are fluidly connected to a face (1004) of the membrane (404) and/or an exterior of the breathable plug (1102), and further optionally
wherein a gate labyrinth (1006) is provided between a one of the one or more gates (1002) and the membrane (404) and/or the exterior of the breathable plug (1102).

9. The breathable plug (1102) of claim 1, further comprising a resilient seal (1008) arranged to form a fluid tight seal between the breathable plug (1102) and a surface.

10. The breathable plug (1102) of claim 9, wherein the resilient seal (1008) is formed by overmolding on the breathable plug (1102).

11. The breathable plug (1102) of claim 9, wherein the breathable plug (1102) is provided with one or more keying features (1104) which the resilient seal (1008) is overmolded onto.

12. The breathable plug (1102) of claim 9, wherein the resilient seal is arranged on a fixture body.

13. The breathable plug (1102) of claim 9, wherein the keying features have a cross section which is dovetail like in shape.

14. A breathable plug fixture (102), suitable to prevent the passage of liquid droplets, comprising a breathable plug (108) of claim 1, wherein the breathable plug fixture comprises a fixation portion (104) having an aperture (106) arranged to receive the breathable plug.

15. A breathable plug fixture (102), suitable to prevent the passage of liquid droplets, comprising a breathable plug (108) of claim 1, wherein the breathable plug (108) is associated with the aperture (106).

16. The breathable plug of claim 1,
wherein the one or more wings are arranged to capture liquid droplets and/or to direct the captured liquid droplets, and/or
wherein the one or more wings are attached to at least one flank of the resilient external thread.

17. The breathable plug of claim 1,
wherein the one or more wings at least partially occlude a gap formed between opposing flanks of the resilient external thread, and/or
wherein the one or more wings vary in size and/or shape and/or topology.
